(19) United States
(12) Patent Application Publication
(10) Pub. No.: US 2024/0021835 A1
(43) Pub. Date: Jan. 18, 2024

(54) 3D Electrode Design for a High Specific-capacity Al-graphite Dual-ion Battery

(71) Applicant: Massachusetts Institute of Technology, Cambridge, MA (US)

(72) Inventors: Yang Shao-Horn, Newton, MA (US); Yun Guang Zhu, San Diego, CA (US)

(73) Assignee: Massachusetts Institute of Technology, Cambridge, MA (US)

(21) Appl. No.: 18/316,464

(22) Filed: May 12, 2023

Related U.S. Application Data
(60) Provisional application No. 63/389,330, filed on Jul. 14, 2022.

(51) Int. Cl. H01M 4/62; H01M 4/38; H01M 10/054; H01M 10/0569; H01M 4/04; H01M 4/134

(52) U.S. Cl. CPC H01M 4/625; H01M 4/38; H01M 4/623; H01M 10/054; H01M 10/0569; H01M 4/0485; H01M 4/134; H01M 2300/0028

(57) ABSTRACT

An aluminum electrode can include gel polymer as the binder, which can be combined with a carbon electrode to form a dual-ion battery.

### PRIORITY CLAIM

This application claims priority from U.S. Provisional Patent Application No. 63/389,330, filed Jul. 14, 2022, which is incorporated by reference in its entirety.

### FIELD OF THE INVENTION

The invention relates to compositions suitable for electrode materials for batteries.

### BACKGROUND

With the increasing demands of Li-ion batteries for energy storage in the future, the foreseen shortage of some elements currently used in electrodes (e.g., cobalt) will become a big challenge. (ref. 1) Therefore, it is eager to develop alternative battery chemistries, such as Zn-ion (ref. 2) and Al-ion batteries (ref. 3), to replace the state-of-the-art lithium-ion batteries in some applications (e.g., stationary energy storage) with a slightly lower energy densities requirement.

### SUMMARY

In one aspect, an aluminum electrode for a battery can include an aluminum powder and a gel polymer as a binder. In certain circumstances, the aluminum electrode can include an electrically conductive network.

In another aspect, a carbon electrode for a battery can include a carbon powder and a gel polymer as a binder.

In another aspect, a dual-ion battery can include an aluminum electrode as described herein and an electrolyte. In certain embodiments, the dual-ion battery can include a carbon electrode as described herein. The dual-ion battery can include a separator between the aluminum electrode and the carbon electrode.

In another aspect, method of manufacturing an electrode can include casting a mixture of a gel polymer and an electrically conductive material selected from the group consisting of carbon black, a carbon nanomaterial, graphene, graphite, a conductive polymer, acetylene black, or ketjen black, or inert metal particles to form a wet film; and drying the wet film. In certain circumstances, the mixture can include metal particles. In certain circumstances, the metal particles can be aluminum particles or aluminum powder.

In certain circumstances, the electrically conductive network can include carbon black, a carbon nanomaterial (such as carbon nanotubes or fullerenes), graphene, graphite, a conductive polymer, acetylene black, ketjen black, or inert metal particles. For example, the electrically conductive network can include acetylene black or graphite powder.

In certain circumstances, the carbon powder can include carbon black, a carbon nanomaterial (such as carbon nanotubes or fullerenes), graphene, graphite, a conductive polymer, acetylene black, or ketjen black. For example, the electrically conductive network can include acetylene black.

In certain circumstances, the gel polymer can include a fluorinated polyolefin, polyacrylonitrile (PAN), poly(ethylene oxide) (PEO), poly(vinylidene fluoride) (PVDF), or poly(methyl methacrylate) (PMMA). In certain circumstances, the fluorinated polyolefin can include a polyvinylidene fluoride, a polytetrafluoroethylene, a polyhexafluoropolypropylene, or a combination thereof. In certain circumstances, the fluorinated polyolefin can be a copolymer of a polyvinylidene fluoride, a polytetrafluoroethylene, a hexafluoropolypropylene, or a combination thereof. For example, the gel polymer can include poly(vinylidene fluoride)-co-hexafluoropropylene.

In certain circumstances, the electrolyte can include an ionic liquid electrolyte. In certain circumstances, the ionic liquid electrolyte can include a chloride salt. In certain circumstances, the ionic liquid electrolyte can include an imidazolium chloride. For example, the ionic liquid electrolyte can include 1-ethyl-3-methylimidazolium chloride and aluminum chloride.

Other aspects, embodiments, and features will be apparent from the following description, the drawings, and the claims.

### BRIEF DESCRIPTION OF THE DRAWINGS

FIGS. 1A-1B depict a schematic structure of the 3D Al/AB/PVDF-HFP film electrode (FIG. 1A) and an SEM image of the 3D Al/AB/PVDF-HFP_1 film electrode (˜80 μm in thickness) (FIG. 1). The scale bar represents 10 μm.

FIG. 1C depicts an aluminum electrode.

FIG. 1D depicts a carbon electrode. FIGS. 2A-2F depict features of the materials described herein. FIGS. 2A-2C show SEM images of Al/AB/PVDF-HFP_1 (FIG. 2A), 2 (FIG. 2B), and 3 (FIG. 2C), containing 7.3, 3.6, and 2.7 w % AB, respectively. The inset in each figure is the photo of the corresponding film electrode. The scale bar for each SEM image is 10 mm. FIGS. 2D-2F show cyclic voltammetry (CV) curves of Al/AB/PVDF-HFP_1 (FIG. 2D), 2 (FIG. 2E), and 3 (FIG. 2F), containing 7.3, 3.6, and 2.7 w % AB, respectively. The electrodes were tested in a symmetric cell, with two pieces of Al/AB/PVDF-HFP film electrodes decoupled by a piece of GF/D glass fiber separator. The scan rate was 1 mV/s with operation voltage window of −0.8 to 0.8 V.

FIG. 3A is a graph depicting the charge/discharge curves of Al/AB/PVDF-HFP_1, 2, and 3, containing 7.3, 3.6, and 2.7 w % AB, respectively. The measurements were tested in symmetric cells. The applied current is 1 mA/cm²_{geo}. The areal capacity for each sample was set as 1 mAh/cm²_{geo}. FIG. 3B is a graph depicting charge/discharge profiles of an Al plate/stainless steel (SS) plate are asymmetric (in green) and Al/AB/PVDF-HFP_1 electrode symmetric cells (in red). The applied currents were from 1 to 20 mA/cm²_{geo}. The charge/discharge capacity was set at 1 mAh/cm²_{geo}. The separator is a GF/D glass fiber separator. ˜120 μl of EMICl/AlCl₃ (⅔ in mole) were added in each cell.

FIG. 3C depicts a schematic of an Al/AB/PVDF-HFP symmetric cell structure for electrochemical performance testing.

FIG. 3D depicts a schematic of an Al plate/stainless steel (SS) asymmetric cell structure for electrochemical performance testing.

FIG. 3E depicts a schematic of an Al/AB/PVDF-HFP electrode—graphite/PVDF-HFP electrode asymmetric cell structure for electrochemical performance testing.

FIG. 4A is a graph depicting a cyclic voltammetry curve of an Al plate/stainless steel (SS) plate asymmetric cell with a scan rate of 1 mV/s in an operation window of −0.8 to 0.8 V. FIGS. 4B-4D are graphs depicting the charge/discharge profiles of the Al plate/stainless steel (SS) plate asymmetric cell at current densities of 1, 2, 5 mA/cm²_{geo} selected from FIG. 3D. The charge/discharge areal capacity was set as 1 mA/cm²_{geo}. The charge and discharge cut-off voltages are 0.8 and −0.8 V, respectively.

FIGS. 5A-5F are images of cycled components. FIG. 5A is a photograph of cycled SS electrode and FIG. 5D is a photograph of a glass fiber separator of an Al plate/stainless steel (SS) plate asymmetric cell (FIG. 3D). The SEM and EDS images of cycled SS electrode are shown in FIG. 5B and FIG. 5C, respectively, and glass fiber separator in FIG. 5E and FIG. 5F, respectively. The scale bars of the SEM and EDS images represent 5 μm.

FIGS. 6A-6F are graphs depicting electrochemical properties of a cell. FIG. 6A shows a cyclic voltammetry curve of Al/AB/PVDF-HFP_1 symmetric cell with a scan rate of 1 mV/s in an operation window of −0.8 to 0.8 V. FIGS. 6B-6F show the charge/discharge profiles of the AU/AB/PVDF-HFP_1 electrode symmetric cell at current densities of 1, 2, 5, 10, and 20 mA/cm²_{geo} selected from FIG. 3C. The charge/discharge capacity was set as 1 mA/cm²_{geo}.

FIGS. 7A-7D are photographs depicting SEM and EDS (C K in (FIG. 7B), F K in (FIG. 7C), and Al K in (FIG. 7D)) images of the Al/AB/PVDF-HFP_1 film electrode. The AB are well distributed in the PVDF-HFP matrix. The scale bars of the SEM and EDS images represent 20 μm.

FIGS. 8A-8F are photographs depicting SEM and EDS (C K in (FIG. 8B), F K in (FIG. 8C), O K in (FIG. 8D), Al K in (FIG. 8E), and Cl K in (FIG. 8F)) images of the cycled Al/AB/PVDF-HFP_1 film electrode (FIG. 3D). The C and F are well distributed in the PVDF-HFP matrix. The O K should be attributed to the oxidation of plated Al on AB. There is a small amount of Cl on the electrode film from the residual EMICl/AlCl₃ (⅔ in mole). The scale bars of the SEM and EDS images represent 20 μm.

FIGS. 9A-9D are SEM images of the graphite foil (FIG. 9A and FIG. 9B) and graphite film electrode (FIG. 9C and FIG. 9D).

FIGS. 10A-10F are graphs depicting CV curves of Al/graphite battery with natural graphite foil (FIG. 10A) and 3D graphite film electrode (FIG. 10B). The scanning rate in the above CV measurements was 0.2 mV/s in the operating voltage window from 0.5 to 2.5 V_{Al} (FIG. 10C). The galvanostatic charge/discharge curves of Al/graphite foil (in grey) or Al/AB/PVDF-HFP|3D graphite (in blue) at a current density of 186 mA/gc with a voltage window from 0.5 to 2.5 V_{Al} (FIG. 10D). The voltage profiles of the Al/AB/PVDF-HFP/3D graphite cells at different current densities (186, 374, and 744 mA/gc) (FIG. 10E). The specific discharge capacities and Coulombic efficiency (CE) at different current densities (186, 374, and 744 mA/gc) (FIG. 10F). The specific discharge capacities and Coulombic efficiency (CE) at a high current density of 2980 mAh/gc for 3000 cycles.

FIG. 11 is a graph depicting the specific discharge capacity of graphite foil with cycling numbers. The applied current was 186 mA/gc. The cut-off charge and discharge voltages were set as 2.5 and 0.6 V.

FIG. 12 is a graph depicting the 1^{st} cycle CV curve of the 3D graphite film electrode. The scanning rate in the CV measurement was 0.2 mV/s in the operation voltage window from 0.5 to 2.5 V_{Al}.

FIGS. 13A-13C are graphs depicting charging characteristics of a cell. FIG. 13A shows the GITT curve in the charging process of the Al/graphite cell. The cell was firstly charged at a current density of 35 mA/gc for 10 mins and then kept rest for 1 h or after the decaying voltage rate was less than 0.1 mV/h. P1 (FIG. 13B) and P2 (FIG. 13C) selected from (FIG. 13A) were used to calculate the diffusion coefficients of AlCl₄⁻ in graphite in the redox steps.

FIG. 14 is a graph showing the CV curves of an asymmetric graphite foil/glassy carbon cell (in black) and a symmetric graphite foil/graphite foil cell (in blue). Through integration, the area of CV curve from graphite foil is ˜62 times higher than glassy carbon electrode, suggesting that graphite foil have 62 times higher surface area than the glassy carbon with same geometric area. The electrolyte in the cell was used 1 M KCl.

FIG. 15A-15H show various characteristics of the electrodes described herein. The voltage profile at a current density of 186 mA/cm² and corresponding Raman spectra from an Al/AB/PVDF-HFP|3D graphite in-situ Raman cell in cycle 3 (FIG. 15A and FIG. 15B) and 100 (FIG. 15C and FIG. 15D). Each spectrum was collected in 3 mins with 600 gratings using a 632.8 nm laser. The cut-off voltages are 0.5 V in the discharge and 2.5 V in the charge. The SEM (FIG. 15E) and EDS images (C in (FIG. 15F), Al in (FIG. 15G), and Cl in (FIG. 15H)) of a fully charged 3D graphite electrode (140 mAh/gc) after washing and drying.

FIG. 16A is a graph depicting the XRD patterns of the pristine (in grey) and the fully charged 3D graphite film (in blue) electrodes.

FIG. 16B is a graph depicting the Raman spectra of the 3D graphite film electrode in pristine, after 12 h OCV and after 3, 9, 30 charge/discharge cycles with current density of 186 mA/gc.

### DETAILED DESCRIPTION

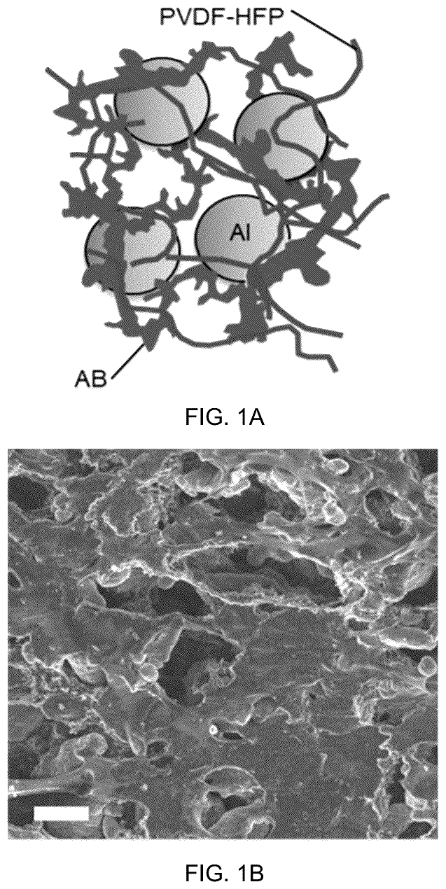

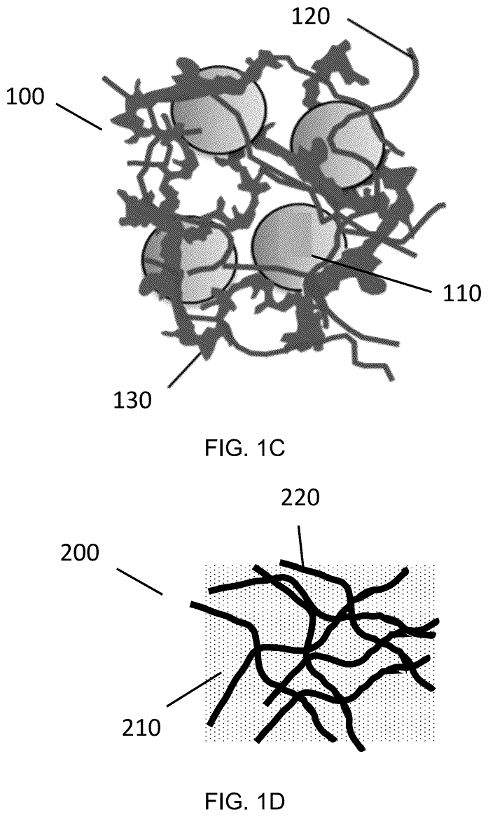

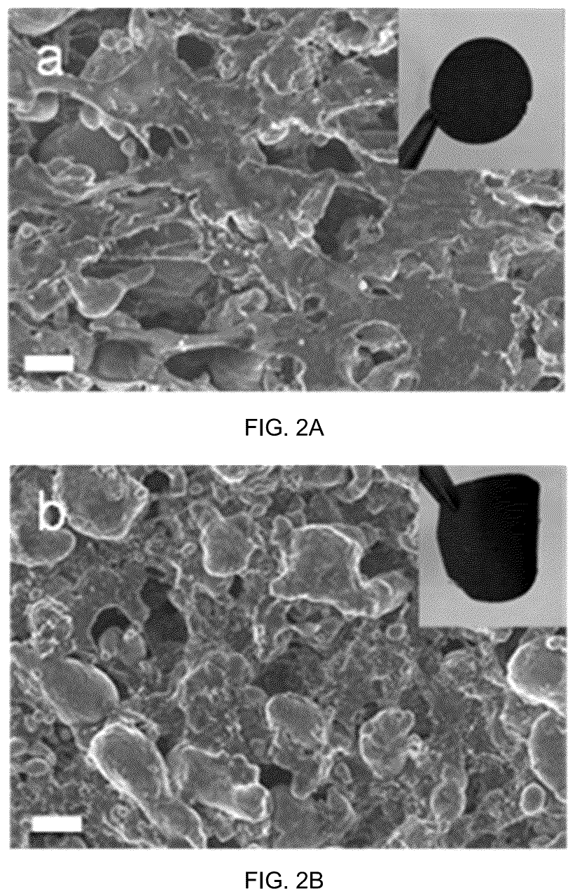

A membrane for use to prepare an electrode for a rechargeable battery can include an aluminum electrode 100 including aluminum powder 110 and a gel polymer 120 as a binder, an example of which is shown in FIG. 1C. The membrane can include an electrically conductive network 130.

A membrane for use to prepare an electrode for a rechargeable battery can include a carbon electrode 200 including carbon powder 210 and a gel polymer 220 as a binder, an example of which is shown in FIG. 1D.

The electrode can be a membrane electrode. The electrode can be manufactured by, for example, casting a mixture of a gel polymer and an electrically conductive material selected from the group consisting of carbon black, a carbon nanomaterial, graphene, graphite, a conductive polymer, acetylene black, or ketjen black, or inert metal particles to form a wet film; and drying the wet film. In certain circumstances, the mixture can include metal particles. In certain circumstances, the metal particles can be aluminum particles or aluminum powder.

The electrically conductive network can include carbon black, a carbon nanomaterial (such as carbon nanotubes or fullerenes), graphene, graphite, a conductive polymer, acetylene black, ketjen black, or inert metal particles. For example, the electrically conductive network can include acetylene black or graphite powder.

The carbon powder can include carbon black, a carbon nanomaterial (such as carbon nanotubes or fullerenes), graphene, graphite, a conductive polymer, acetylene black, or ketjen black. For example, the electrically conductive network can include acetylene black.

The gel polymer is a polymer composition that can form an open network to support particles, such as the metal particles, and an electrically conductive material, for example a carbon powder. The gel polymer can swell with electrolyte and permit exchange of ionic species in an electrode as oxidation or reduction reactions occur at the electrode. The gel polymer can include a fluorinated polyolefin, polyacrylonitrile (PAN), poly(ethylene oxide) (PEO), poly(vinylidene fluoride) (PVDF), or poly(methyl methacrylate) (PMMA).

The fluorinated polyolefin can include a polyvinylidene fluoride, a polytetrafluoroethylene, a polyhexafluoropolypropylene, or a combination thereof. In certain circumstances, the fluorinated polyolefin can be a copolymer of a polyvinylidene fluoride, a polytetrafluoroethylene, a polyhexafluoropolypropylene, or a combination thereof. For example, the gel polymer can include poly(vinylidene fluoride)-co-hexafluoropropylene. The copolymer can have 10 wt %, 20 wt %, 30 wt %, 40 wt % or 50 wt % of any one of the component polymers.

The electrolyte can include an ionic liquid electrolyte. In certain circumstances, the ionic liquid electrolyte can include a chloride salt. In certain circumstances, the ionic liquid electrolyte can include an imidazolium chloride. For example, the ionic liquid electrolyte can include 1-ethyl-3-methylimidazolium chloride and aluminum chloride.

Al-metal based batteries are promising candidates for energy storage because of the naturally abundant and low-cost aluminum metal. (ref. 4) Although low-cost and safe aqueous Al-based batteries (e.g., Al-air (refs. 5, 6), Al-sulfur (ref. 7)) are promising the corrosion and passivation of Al electrode (refs. 8, 9) would be a big challenge to realize long cycling life. Some non-aqueous Al-ion systems with organic electrolytes were demonstrated but the reversibility and conductivity still have a large room to improve. (refs. 10, 11) Recently, Al-graphite dual ion batteries with chloroaluminate-based ionic liquids are studied intensively due to their high operation voltage (up to 2.5 V) and good cycling stability (>1000 cycles). (ref. 12) However, the irreversibility of Al electrode and dendrite formation (refs. 13, 14) in the plating/stripping process would be significant challenges, limiting Al-ion batteries cycling life. To conquer the above issues, Zheng et al. designed a high surface area carbon substrate that enables the homogeneous and reversible Al plating/stripping by utilizing oxygen-mediated chemical bonding between Al deposits and the substrate. (ref. 13) More importantly, the difficult intercalation of large AlCl₄⁻ ions into bulky graphite limits the utilization of graphite, which leads to a low specific capacity of graphite foils (<70 mAh/gc) (ref. 3). In addition, chloroaluminate-based electrolytes are corrosive, leading to the high requirement on the current collectors. Currently, the stable current collectors are W, Mo, etc. (refs. 15, 16), which will dramatically increase the cost of the Al-graphite dual ion battery.

Therefore, it is eager to find a practical solution to overcome the above-mentioned three challenges. As described herein, poly(vinylidene fluoride)-co-hexafluoropropylene (PVDF-HFP) copolymer was employed to make three-dimensional (3D) thin film Al anode and graphite cathode. In the 3D Al film electrode, a small amount of high-surface-area acetylene black (AB), which plays both conductive network and Al plating substrate, was introduced resulting in a high rate (˜0.18 V of overpotential at 20 mA/cm²_{geo}) and long cycle life (>500 h). The natural graphite foil can be used as a free-standing electrode, but the electrode gradually decays with cycling due to the volume expansion from AlCl₄⁻ intercalation (ref. 3) and has low specific capacity (refs. 3, 17, 18). Therefore, nature graphite particles with a high surface area were used to replace graphite foils to increase the specific capacity up to ˜140 mAh/gc. (ref. 19) In the 3D graphite electrode, the continuous ionic network could efficiently/evenly deliver AlCl₄⁻ to the graphite particles, leading to an almost three times higher capacity (142 mAh/gc) than natural graphite foil (51 mAh/gc). The design of free-standing Al and graphite film electrodes provides a promising solution to scale up the Al-graphite dual ion batteries with high rate capability and cycling stability.

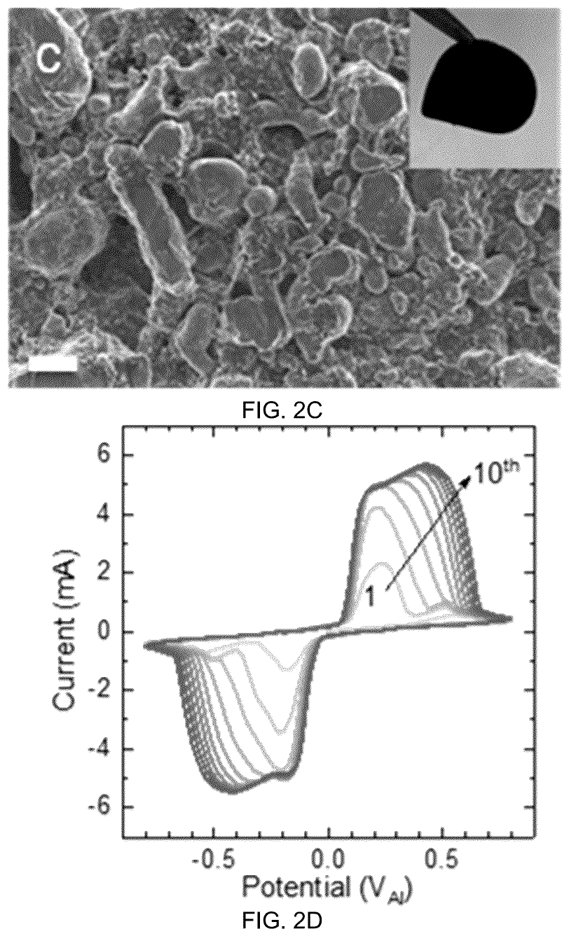

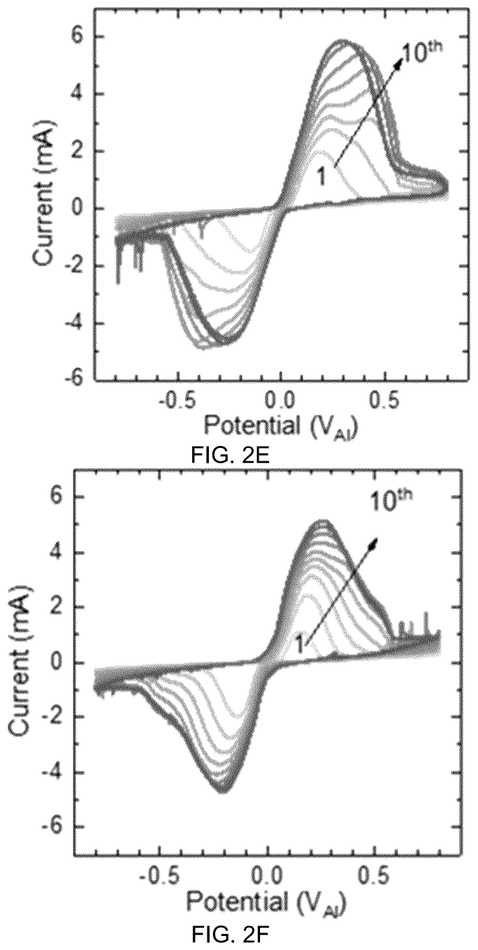

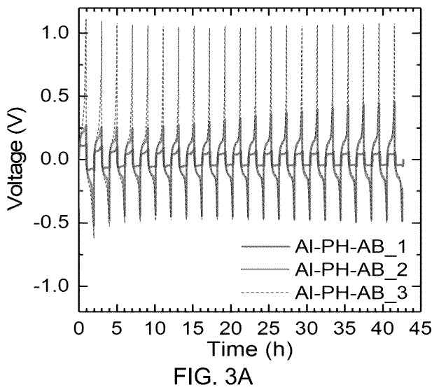

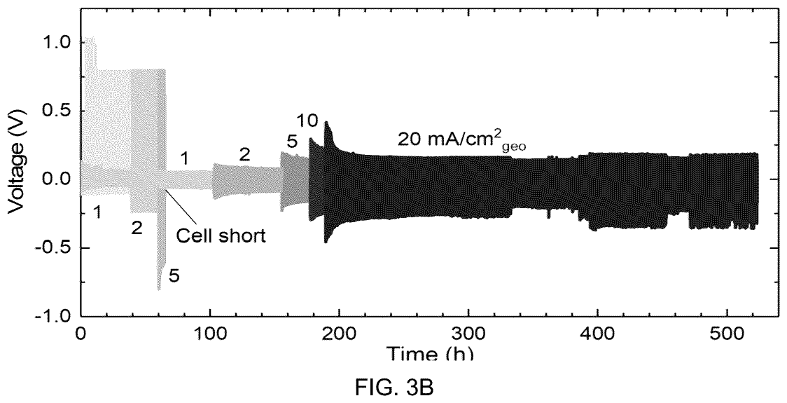

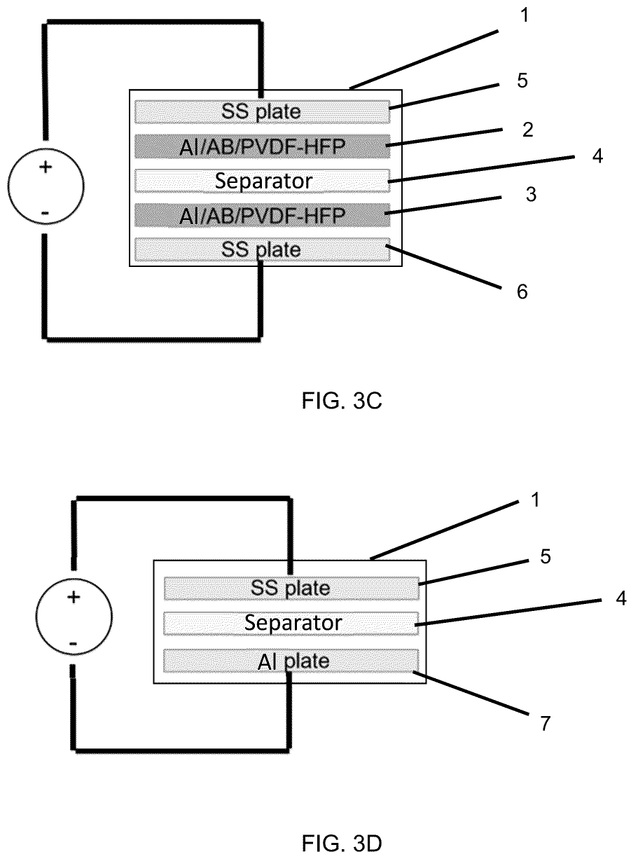

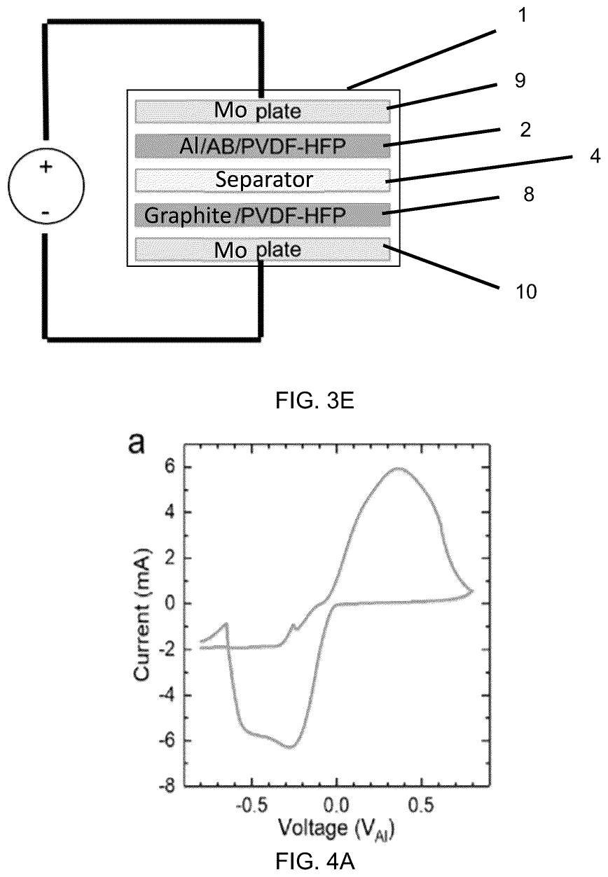

FIG. 3C schematically illustrates a symmetric battery 1, which includes electrode 2, electrode 3, separator 4, anode collector 5, and cathode collector 6. FIG. 3D schematically illustrates an asymmetric battery 1, which includes separator 4, collector 5, and collector 6. FIG. 3E schematically illustrates a battery 1, which includes electrode 2, electrode 8, separator 4, collector 9, and collector 10. The battery can be a dual-ion battery. While FIGS. 3C-3E show examples of materials for each of the elements identified, the structures can be generalized to the materials described herein. Each of collector 5, collector 6, collector 7, and collector 8 can each be a same metal surface or a different metal surface. For example, each collector can include a stainless steel surface, a molybdenum surface, a tungsten surface, or an aluminum surface, respectively. Electrolyte 4 can include a separator. Each of electrode 2 and electrode 3 can be an aluminum electrode as described herein. Electrode 8 can be a graphite electrode as described herein. In certain embodiments, one of the two electrodes can include a plurality of metal particles, such as aluminum, for example, aluminum powder. Battery 1 can be solvent free or can include an amount of an aprotic solvent such as an organic solvent, for example, propylene carbonate (PC), ethylene carbonate (EC), or porous inorganic particles, for example, silicon dioxide, or combinations thereof.

An electrode can include a gel polymer. The gel polymer can include a fluorinated polyolefin polyacrylonitrile (PAN), poly(ethylene oxide) (PEO), poly(vinylidene fluoride) (PVDF), or poly(methyl methacrylate) (PMMA). The gel polymer can support an electrically conductive material to form a material useful to form an electrode. As an electrode, the gel polymer and electrically conductive material. Alternatively, the electrode can include a gel polymer and a carbon powder. The electrode can support an electrolyte, such as an ionic liquid electrolyte. The gel polymer can form a network to support a plurality of metal particles, which can be an active material oxidized during battery cycling (for example, discharging and charging cycles). The electrolyte can include the metal in cationic form and an anion. When the metal is aluminum, the cation can be an aluminum cation and the anion can be an aluminum anion.

The separator can be a porous polymer matrix, such as a gel polymer (in the absence of a conductive material), a porous fabric, such as fiberglass, a glass frit or a glass fiber mat. The separator can have a thickness of between 5 microns and 100 microns, between 10 microns to 80 microns, between 20 microns and 60 microns, and 25 microns to 40 microns. For example, the membrane can have a thickness of about 30 microns.

An electrode can be manufactured by creating a mixture including the gel polymer and a conductive material, and casting the mixture to form a wet film. The wet film is then dried to form the membrane. When the mixture further includes the plurality of metal particles, the dried film can be a battery electrode. The electrode can have a thickness of between 5 microns and 100 microns, between 10 microns to 80 microns, between 20 microns and 60 microns, and 25 microns to 40 microns. For example, the electrode can have a thickness of about 5 microns to about 30 microns.

The fluorinated polyolefin can include a polyvinylidene fluoride, a polytetrafluoroethylene, a polyhexafluoropolypropylene, or a combination thereof. For example, the fluorinated polyolefin can include a copolymer of a polyvinylidene fluoride, a polytetrafluoroethylene, a polyhexafluoropolypropylene, or a combination thereof. In preferred embodiments, the fluorinated polyolefin can be poly(vinylidene fluoride)-co-hexafluoropropylene. The fluorinated polyolefin can have an average molecular weight of between 50,000 and 500,000. For example, the weight average molecular weight can be between 300,000 and 500,000. The number average molecular weight can be between 80,000 and 140,000.

The amount of gel polymer in an electrode can be between 5 wt % and 70 wt %, between 10 wt % and 60 wt %, between 15 wt % and 40 wt %, or between 20 wt % and 30 wt %.

The electrically conductive material can be an electrically conductive network. For example, the electrically conductive material can include carbon black, a carbon nanomaterial (such as carbon nanotubes or fullerenes), graphene, graphite, a conductive polymer, acetylene black, ketjen black, or inert metal particles. In preferred embodiments, the electrically conductive material can be acetylene black or graphite powder. The amount of electrically conductive material in an electrode can be between 0.5 wt % and 20 wt %, between 1 wt % and 15 wt %, or between 2 wt % and 10 wt %.

Particle sizes disclosed herein are average particle sizes.

The aluminum powder or aluminum particles can have average particle sizes of less than 60 microns, less than 55 microns, less than 50 microns, less than 45 microns, less than 40 microns, less than 35 microns, less than 30 microns, less than 25 microns, less than 20 microns, less than 15 microns, less than 10 microns, or less than 5 microns. For example, the particle size can be between 5 microns and 40 microns. In preferred embodiments, the aluminum powder can be 99% pure or higher purity. The amount of aluminum powder in an electrode can be between 40 wt % and 90 wt %, between 50 wt % and 85 wt %, or between 60 wt % and 80 wt %.

The acetylene black can have average particle sizes of less than 1 micron, less than 0.1 micron, less than 0.075 microns, or less than 0.05 microns.

The graphite powder can have average particle sizes of less than 60 microns, less than 55 microns, less than 50 microns, less than 45 microns, less than 40 microns, less than 35 microns, less than 30 microns, less than 25 microns, less than 20 microns, less than 15 microns, less than 10 microns, or less than 5 microns. For example, the particle size can be between 5 microns and 20 microns. In preferred embodiments, the graphite powder can be 99% pure or higher purity. The amount of graphite powder in an electrode can be between 10 wt % and 70 wt %, between 20 wt % and 60 wt %, or between 30 wt % and 55 wt %, for example, 50 wt %.

The electrolyte can be an ionic electrolyte, for example, an ionic liquid. The ionic electrolyte can include an imidazolium salt. The electrolyte can include the metal in cationic form and the metal in anionic form. For example, aluminum can be an aluminum cation or an aluminum anion, such as aluminum tetrachloride. For example, the electrolyte can include an imidazolium chloride mixed with aluminum trichloride. The molar ratio of imidazolium chloride to aluminum trichloride can be between 1:1 and 1:4, for example, 1:2, 1:3, or 2:3. In one working example, the molar ratio of imidazolium chloride to aluminum trichloride can be 2:3.

In certain circumstances, the metal battery can include a first electrode including an electrically conductive material, and an aluminum powder, a second electrode including a graphite powder, a separator between the first electrode and a second electrode, and an ionic electrolyte. These components can be within a housing, which can be a plastic or inter metal casing. Each electrode can include a gel polymer, for example, a fluorinated polyolefin such as a poly(vinylidene fluoride)-co-hexafluoropropylene. The electrically conductive material can include acetylene black. The ionic liquid electrolyte can include an aluminum anion.

The battery can have a specific capacity of greater than 100 mAh/gc. The battery can have a stability of greater than 500 hr. The battery can have a cycling stability of less than 0.1% decay per cycle based on a fully activated capacity of 2.98 A/gc.

In certain circumstances, a rechargeable Al-graphite dual ion battery is a promising stationary energy storage system due to its low cost and long cycling life. Through engineering both Al and graphite film electrodes using poly(vinylidene fluoride) and poly(vinylidene fluoride)-co-hexafluoropropylene (PVDF-HFP) copolymer as both binder and ionic network, a thin film Al-graphite battery with high specific capacities and rate capabilities was demonstrated. In the Al thin film electrode, high-surface-area acetylene black (AB) was employed as the additional Al plating substrate to dramatically enhance the rate capability (up to 20 mA/cm²_{geo}) and stability (>500 h) of Al plating/stripping. In the graphite thin film electrode, the utilization of graphite can be improved by anchoring graphite particles in the PVDF-HFP ionic network. For example, with modified Al and graphite electrodes, an Al-graphite dual ion battery was realized a specific capacity of ˜140 mAh/gc at a current density of 186 mA/gc (near three times higher than graphite foil) and good cycling stability (˜0.07% decay per cycle based on the fully activated capacity at 2.98 A/gc).

### EXAMPLES

### Materials

Al powder (˜325 mesh, 99.5%, Alfa Aesar) and acetylene black (100% compressed, Strem Chemical Inc.) are used to make Al film electrodes. Nature graphite powder (TIMREX KS10) is used to prepare Graphite film electrodes. Poly(vinylidene fluoride-co-hexafluoropropylene) (PVDF-HFP, MW ˜455000, Sigma Aldrich) is used as the binder and gel-polymer for these film electrodes. Dimethylacetamide (DMA, anhydrous, 99.8%, Sigma Aldrich) is used as the solvent to dissolve PVDF-HFP for the preparation of these film electrodes. Al foil (0.1 mm thick, 99.99%, Thermo Scientific™) and Graphite foil (0.13 mm thick, 99.8%, Alfa Aesar) are used as anode and cathode for the control experiments. The ionic liquid of 1-Ethyl-3-methylimidazolium chloride (EMICl)-aluminum chloride (AlCl₃) (⅔ by mole, Sigma Aldrich) is used as ionic-liquid based electrolytes for Al-based batteries.

### Preparation of Free-Standing Al Electrode

0.75 g of PVDF-HFP pellets were stirred and dissolved in 6 ml DMA at 50° C. for 2 h. 0.1-0.2 g of Acetylene black (AB) and 1.8-2.9 g of Al particles were grounded for 20 min. Then, the above-grounded powder was transferred into the PVDF-HFP solution and stirred overnight at 50° C. The uniform suspension was doctor blended as the Al/AB/PVDF-HFP film electrode with a gap of 100 μm in the argon-filled glove box. Then, the electrode was dried in a Büchi vacuum glass oven at 100° C. for 12 h. After drying, the membranes were stored in the argon-filled glove box for use.

### Preparation of Free-Standing Graphite Electrode

0.75 g of PVDF-HFP pellets were stirred and dissolved in 6 ml DMA at 50° C. for 2h. 0.75 g of graphite particles was transferred into the above PVDF-HFP solution. Then, the uniform suspension was doctor blended as the graphite/PVDF-HFP film electrode with a gap of 100 μm in the atmosphere. Then, the electrode was dried in a Büchi vacuum glass oven at 100° C. for 12 h. After drying, the membranes were transferred into the Ar-filled glove box for use.

### Al-Based Cell Assembling and Testing

Two pieces of Al/AB/PVDF-HFP film electrodes (1.27 cm in diameter) were separated by a piece of glass fiber separator (17 cm diameter, GF/D, Whatman) in a symmetric cell. To understand the cycling stability and rate capability of the Al metal, an asymmetric cell with Al plate (1.27 cm diameter) as a working electrode and stainless steel (SS, 15 cm diameter)) plate as a counter electrode was assembled. For the Al-graphite cell, the Al/AB/PVDF-HFP film electrode was used as the negative electrode and graphite/PVDF-HFP or graphite foil as the positive electrode. To prevent side reactions, two pieces of Mo plates (19 cm diameter) were used spacers in the above cells. The separator in the above cells was GF/D glass fiber separators. 120 μl of EMICl/AlCl₃ (⅔ by mole) electrolyte was used in each cell. The above cells were assembled in homemade metal-air cells. (ref. 20). The galvanostatic charge/discharge measurements were conducted at room temperature at current densities from 1 to 20 mA/cm² for the Al/AB/PVDF-HFP symmetric cells or Al/SS asymmetric cells. The cyclic voltammetry (CV) measurements were performed at room temperature at the scanning rate of 1 mV/s in the potential range from −0.8 to 0.8 V for the Al/AB/PVDF-HFP symmetric cells or Al/SS asymmetric cells. The galvanostatic charge/discharge measurements were conducted at room temperature at current densities from 186 to 3000 mA/gc for Al-graphite cells. The CV measurements were performed at room temperature at the scanning rate of 1 mV/s in the potential range from 0.5 to 2.6 V for Al-graphite cells. In the Galvanostatic Intermittent Titration Technique (GITT) measurement, the Al/graphite cell was tested at a current density of 0.2 mA/cm²_{geo}. The procedure of GITT consisted of galvanostatic charge pulses for each duration time (10 min), followed by a relaxation time (60 min) or dV/dt<0.1 mV/h.

### Characterization of Electrodes

The pristine and cycled Al plate, Al/AB/PVDF-HFP film electrode, graphite/PVDF-HFP film electrode, were characterized using x-ray diffraction (XRD, Bruker D2 Phaser), Raman spectroscopy (HORIBA Scientific LabRAM HR800), scanning electron microscope (SEM, Zeiss Merlin) and energy-dispersive X-ray spectroscopy (EDS). In XRD measurements, the applied voltage and current are 30 kV and 10 mA, respectively, using Cu-Kα radiation (λ=1.54178A). In the Raman spectra measurements, a red laser (λ=632.8 nm) was used with 50-fold magnification. An exposure time of 15 s with 600 gratings was used, and each spectrum was accumulated five times. In the in-situ Raman spectra measurements, each spectrum was collected in 3 mins with 600 gratings. The cycled Al plate, Al/AB/PVDF-HFP, and graphite/PVDF-HFP film electrode were washed using anhydrous acetonitrile (ACN) three times and then dried in a vacuum oven at room temperature.

### Results and Discussion

The Stable 3D Al Film Electrode with a High Rate Capability

To increase the effective surface area of Al for stripping and plating, the 3D matrix of PVDF-HFP copolymer was utilized as a binder and 3D ionic conductivity networks and acetylene black (AB) as a conductive additive, as shown in FIG. 1A. The Al particles are bound by the 3D PVDF-HFP matrix, and nano-sized AB particles are uniformly distributed in the PVDF-HFP, as shown in FIG. 1B. To study the electrochemical percolation threshold of AB in the 3D Al/AB/PVDF-HFP film electrode, the weight ratios of AB was tuned from 2.7 to 7.3 wt %, as shown in Table 1.

TABLE 1
The compositions of three Al/AB/PVDF-HFP film electrodes.

| Sample | Al (w %) | AB (w %) | PH (w %) |
|---|---|---|---|
| Al/AB/PVDF-HFP_1 | 65.4 | 7.3 | 27.3 |
| Al/AB/PVDF-HFP_2 | 69.1 | 3.6 | 27.3 |
| Al/AB/PVDF-HFP_3 | 77.3 | 2.7 | 20.0 |

The SEM images of these film electrodes in FIGS. 2A-2C show more Al particles on the electrode surface with less AB. To understand the electrochemical performance of these three Al-based film electrodes, cyclic voltammetry measurements in symmetric cells were conducted, as shown in FIGS. 2D-2F. There are two pairs of redox peaks at around ±0.21 and ±0.44 V in the CV curves, indicating the Al plating/stripping occurs on two different surfaces. The redox peaks at around ±0.44 V became stronger for the Al film electrode with more AB, suggesting that the Al plating/stripping on AB surface at this voltage. With cycling, the redox peaks at around ±0.44 V became stronger, which should be attributed to that more and more AB surfaces are accessible for the Al plating/stripping.

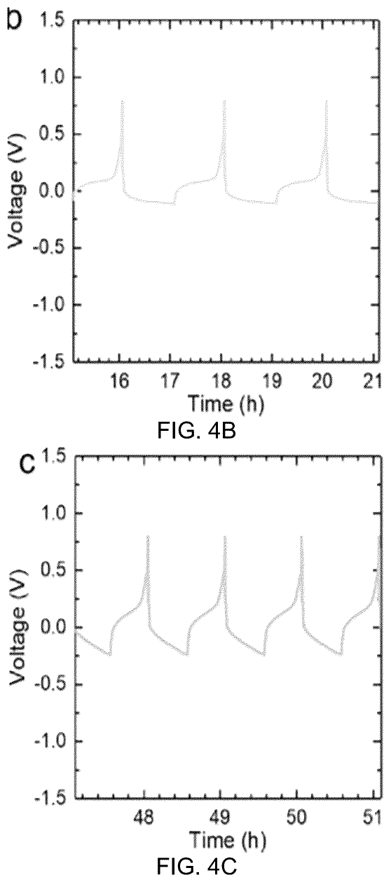

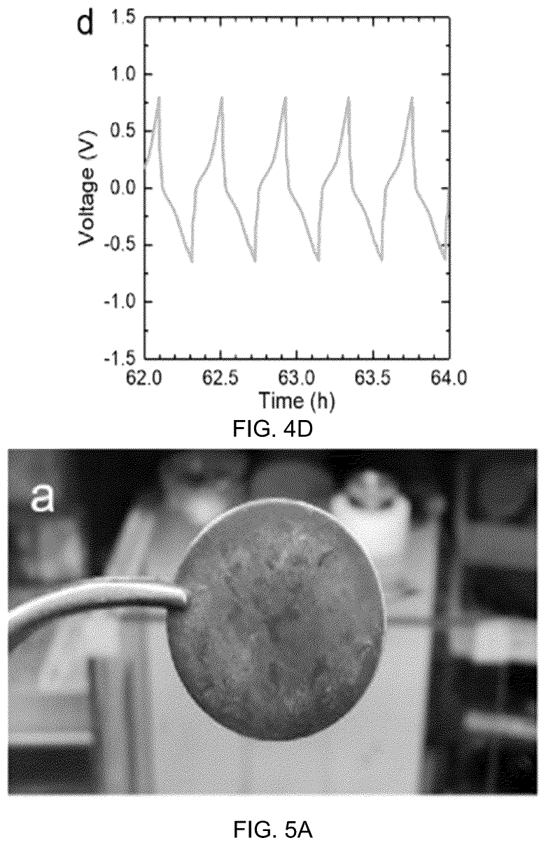

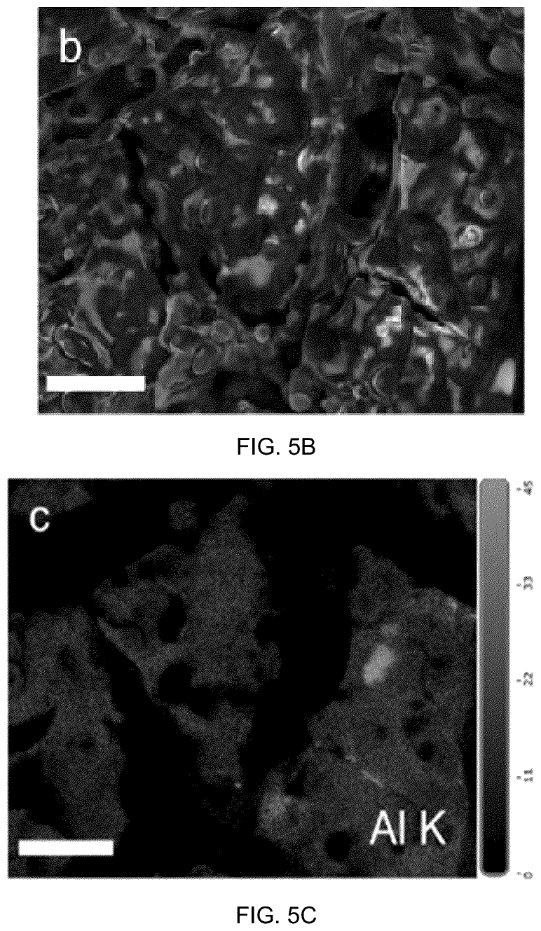

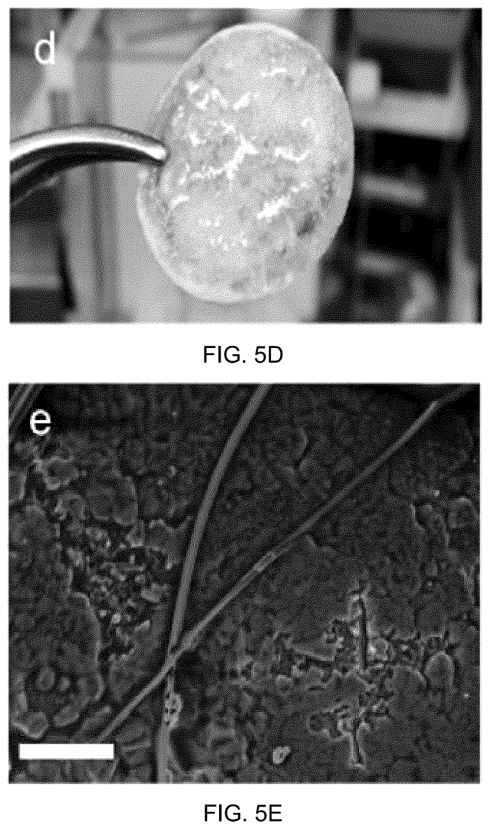

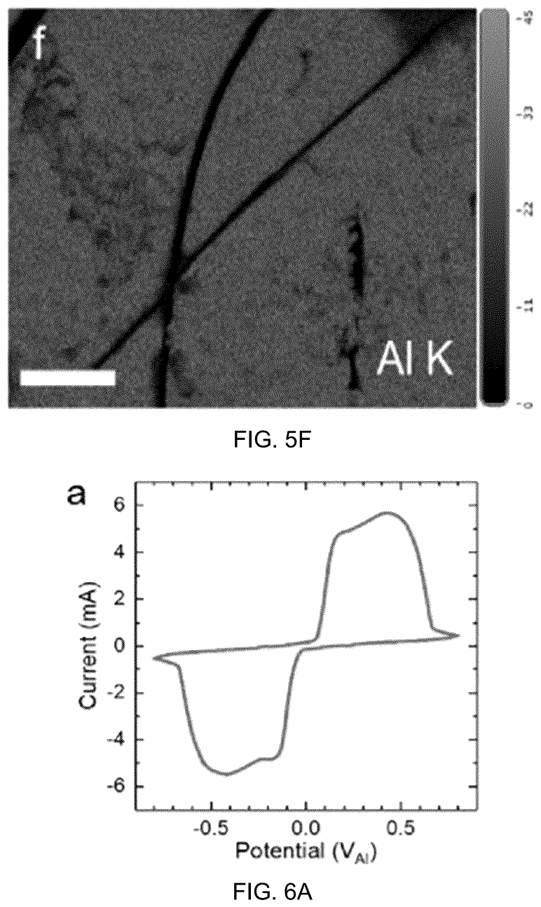

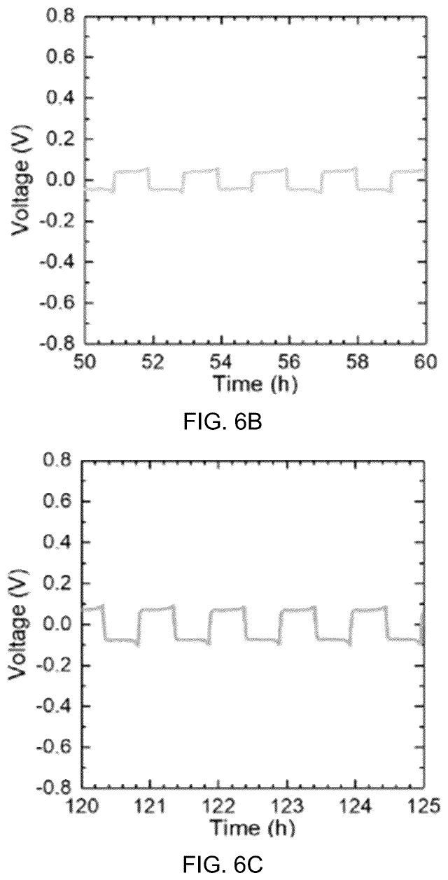

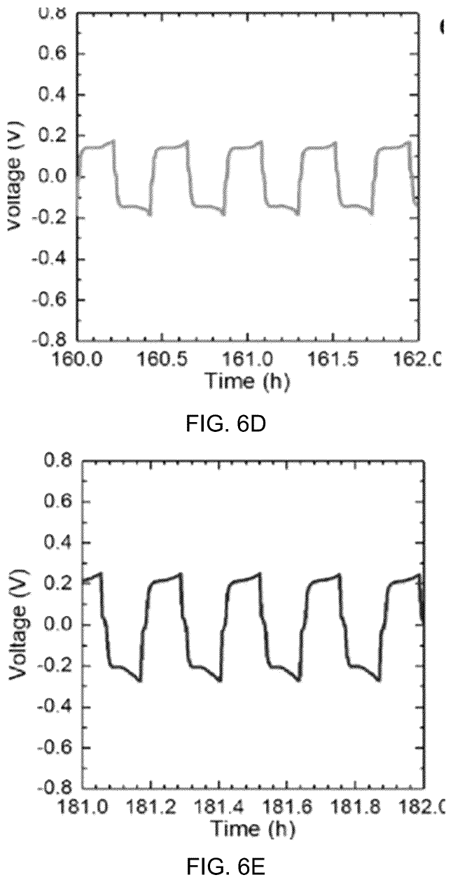

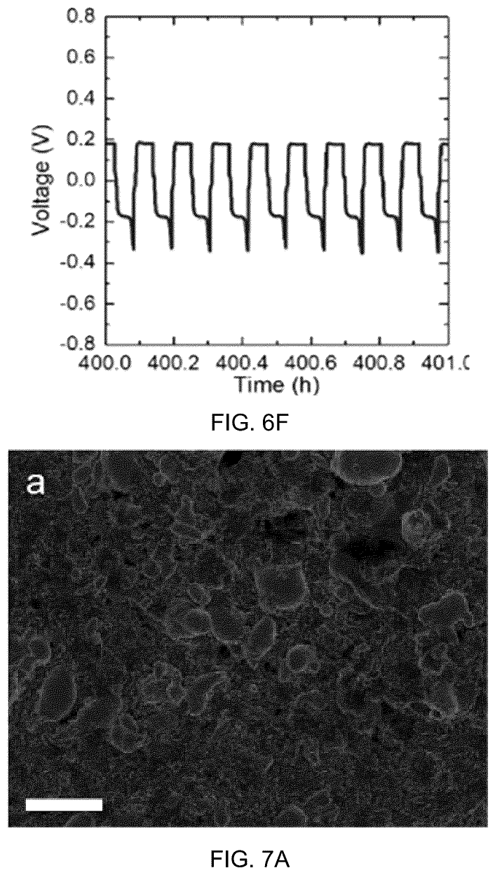

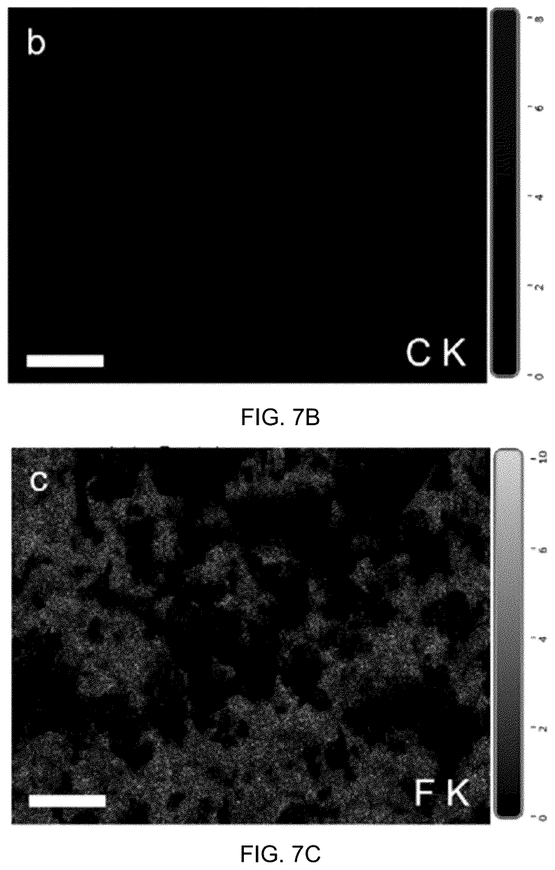

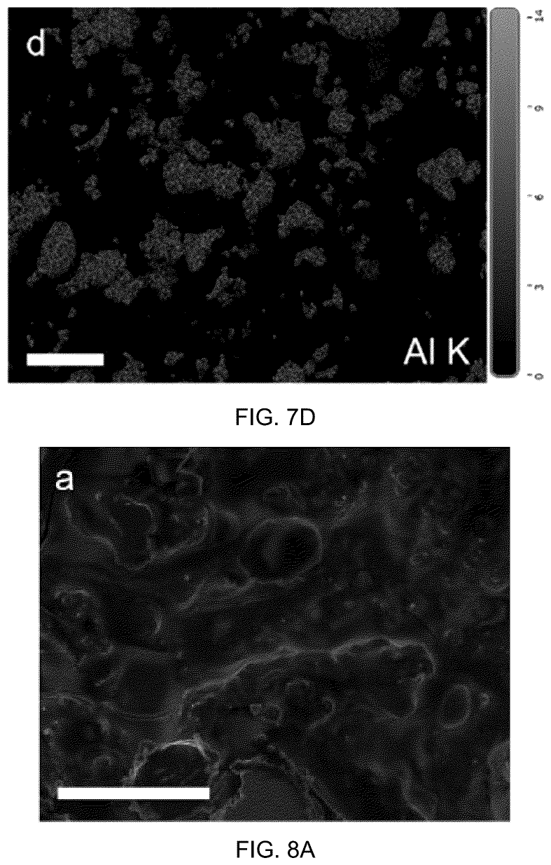

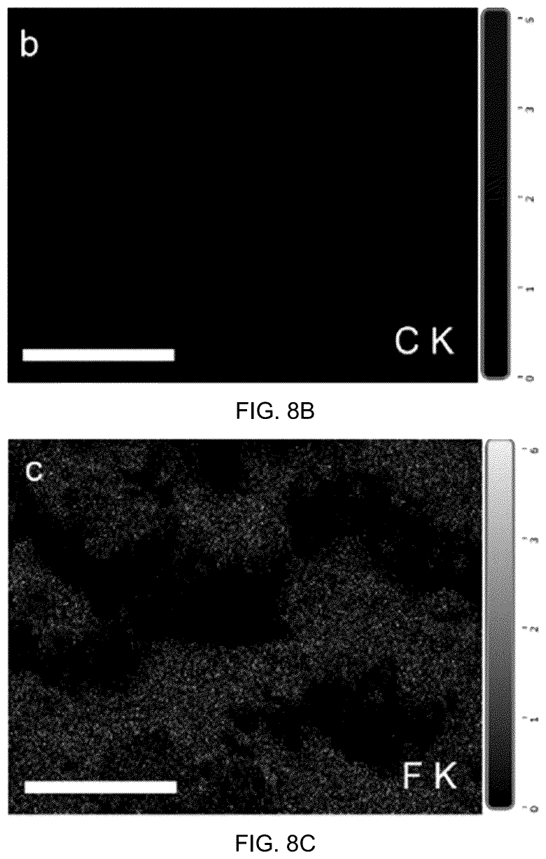

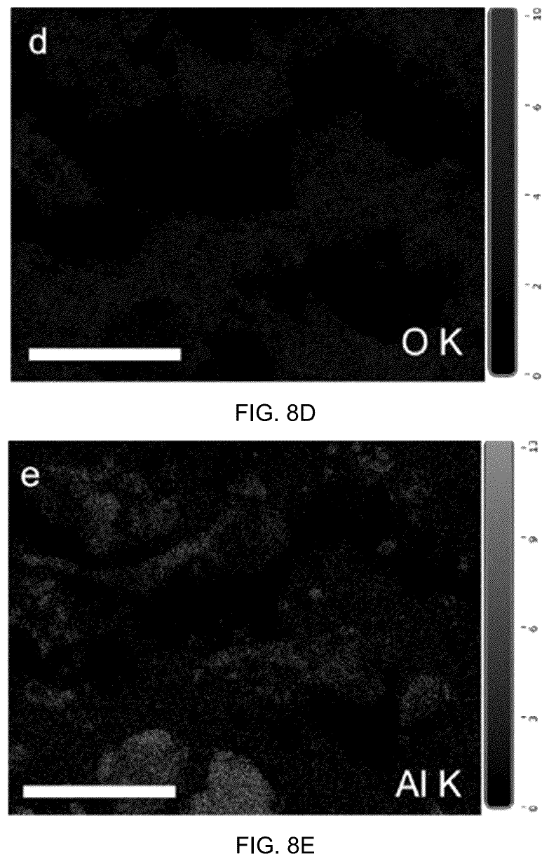

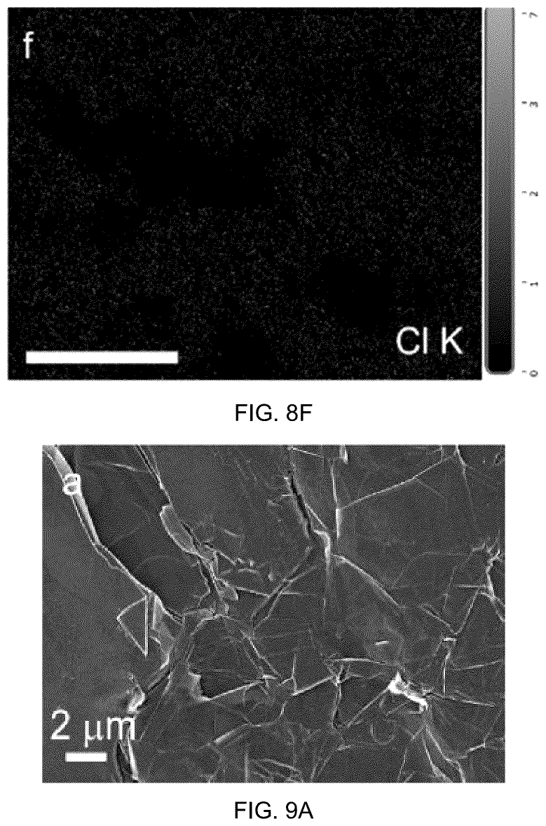

The charge/discharge curves of these three Al-based electrodes with cycling numbers are demonstrated in FIG. 3A. Through comparison, Al/AB/PVDF-HFP_1 with the highest amount of AB (7.3 w %) exhibited the lowest overpotentials (˜0.05 V). In contrast, the other two film electrodes showed similar overpotentials (˜0.13 V) at a current density of 1 mA/cm²_{geo}. Therefore, it was found that 7.3 w % of AB in the film electrode was above the conductivity percolation point while 2.7 and 3.6 w % of AB should be lower than the percolation point. Consequently, the Al/AB/PVDF-HFP_1 was only used to study the electrochemical performance in symmetric Al cells and asymmetric Al/graphite cells in the following sections. As shown in FIG. 3B, the overpotentials of the Al plating/stripping in an Al plate/stainless steel (SS) plate asymmetric cell are much larger than that in an Al/AB/PVDF-HFP_1 electrode symmetric cell. The CV curve of the Al/SS asymmetric cell (FIG. 4A) showed the reversible Al plating/stripping in EMICl/AlCl₃ (⅔ in mole). With the increasing applied current (FIG. 4B-4D), the charge/discharge voltage plateaus became as a slope, indicating the mass-transport limitation on the planar Al or SS electrode. (ref. 21) With a current of 5 mA/cm²_{geo}, the Al/SS asymmetric cell was quickly shorted due to the Al dendrite growth. The cycled SS plate had some plated Al islands due to the uneven plating/stripping, which is supported by the EDS measurements (FIG. 5A-5C). In addition, some plated Al metal grew on the glass fiber separator (FIG. 5D-5F), which could be the reason leading to the cell being short under a high current density (5 mA/cm²_{geo}). As a comparison, Al/AB/PVDF-HFP_1 symmetric cells showed much higher rate capability (˜0.18 V of overpotential at 20 mA/cm²_{geo}) without shorting, indicating that the 3D Al/AB/PVDF-HFP_1 electrode can dramatically increase the plating area for Al, which is consistent with the previous semi-solid Zn and 3D Zn electrode works (refs. 22, 23). The cyclic voltammetry curve after the activation process in FIG. 6A showed two pairs of redox peaks (at around ±0.21 and ±0.44 V), as discussed in the previous section. FIGS. 6B-6F shows the detailed charge/discharged curves of asymmetric Al/AB/PVDF-HFP cell selected in FIG. 3B. It is worth noting that all these charge/discharge cures have flat voltage plateaus, indicating the fast mass transport. Unexpectedly, the PVDF-HFP copolymer works as the gel-polymer electrolyte then shortens the ion diffusion pathway in the 3D Al/AB/PVDF-HFP electrode. Compared to the pristine Al/AB/PVDF-HFP film electrode in EDS (FIGS. 7A-7D), the cycled electrode (FIGS. 8A-8F) showed many blur edges around Al particles, indicating that lots of Al were plated on the AB. In addition, the O distribution in the cycled electrode suggests the oxidation of plated Al on AB or Al particles. The overpotentials of the Al/AB/PVDF-HFP_1 cell (FIG. 3B) gradually decrease with cycling in each rate test, which may be attributed to the change of the diffusion path of Al₂Cl₇⁻ in the PVDF-HFP ionic network. According to the above results and analysis, Al/AB/PVDF-HFP_1 shows much better rate capability and cycling life than planar Al electrode because of the high active surface area and good ionic network. Therefore, Al/AB/PVDF-HFP_1 film electrode was used to investigate the electrochemical performance of Al-graphite dual ion batteries in the following sections.

### The High Specific Capacity Graphite Film Electrode

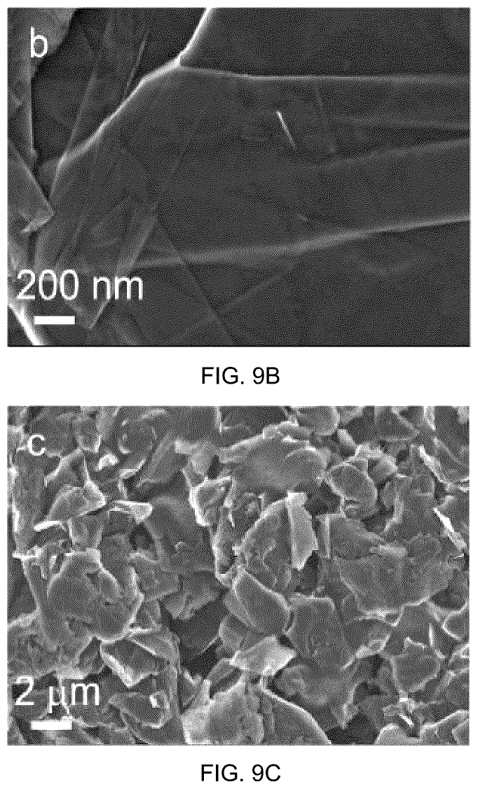

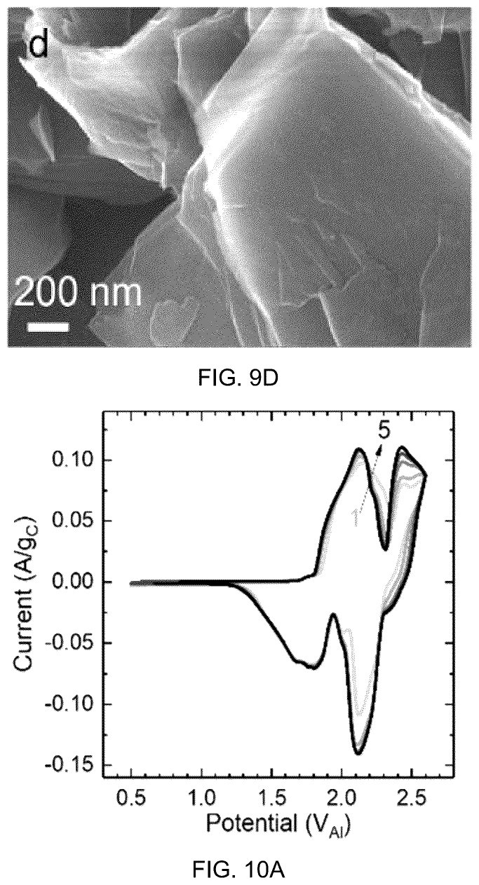

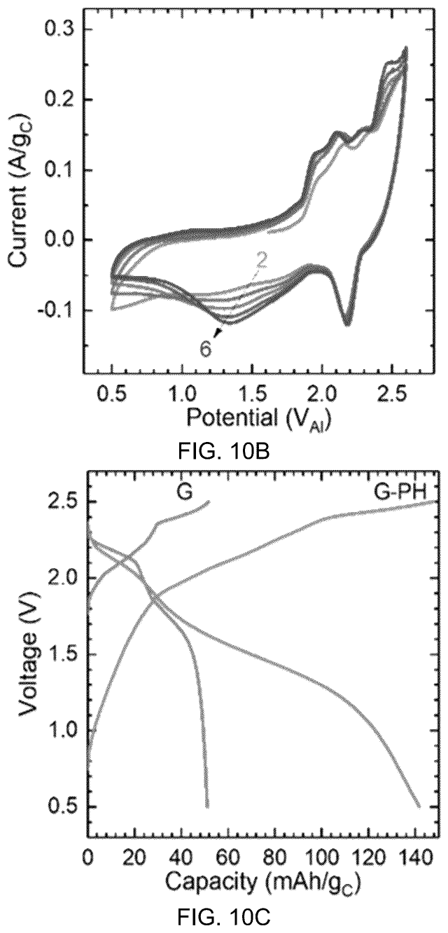

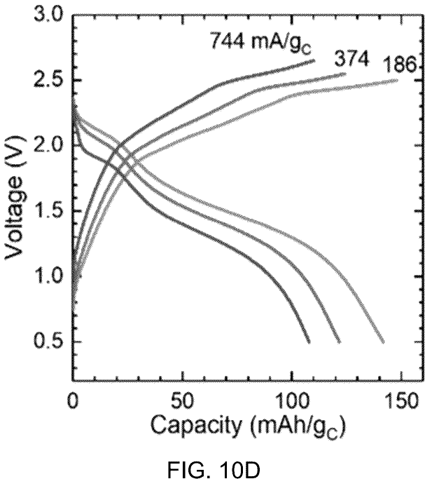

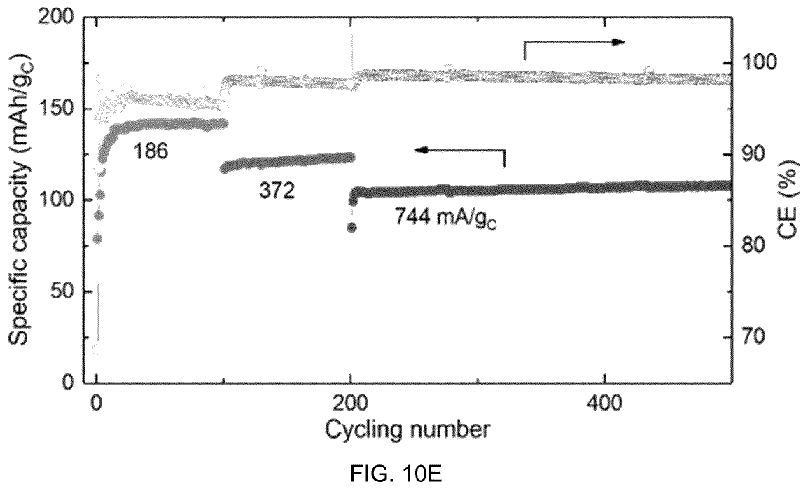

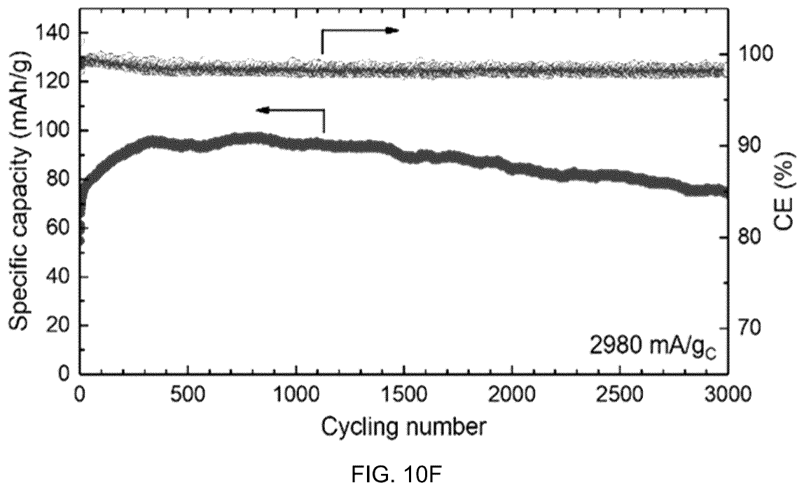

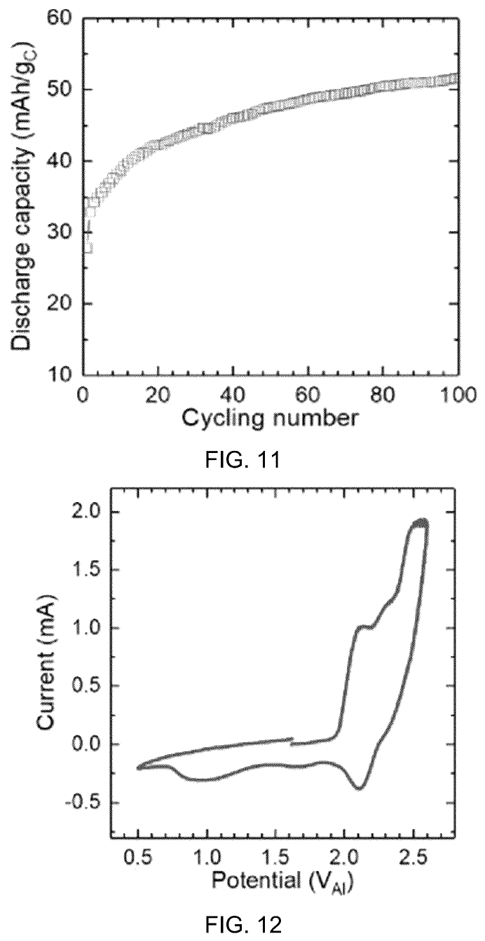

As PVDF-HFP and AB particles from Al/AB/PVDF-HFP film electrodes can provide enough channels for ions and electrons, this a design principle can be used to make a 3D graphite film electrode. The 3D graphite film can be cast using the mixture solution of natural graphite powder and PVDF-HFP/DMA solution without adding conductive additives due to the high conductivity of graphite. As shown in FIGS. 9A-9D, the 3D graphite film (FIGS. 9C-9D) has a much higher surface area than the natural graphite foil (FIGS. 9A-9B). The CV curves of the natural graphite foil (FIG. 10A) show two pairs of redox peaks (2.43/2.11 V_{Al} and 2.12/1.80 V_{Al}). These redox peaks have a slight increase indicating that more AlCl₄⁻ intercalates into the graphite interlayers, which is consistent with the capacity increases with cycling (FIG. 11). The continuous increase in specific capacity with cycling in FIG. 11 suggests that there were still lots of unintercalated graphite interlayer in the graphite foil electrode. For the graphite film electrode, the CV curve in the first cycle (FIG. 12A-) is much different from the following cycles (FIG. 10B), showing some irreversible reactions. The peak currents of the 3D graphite electrode for the two pairs of redox reactions (FIG. 10B) were higher than those in the graphite foil. The redox process of 3D graphite film exhibits multiple redox steps, which may be attributed to much more defects or edges from graphite particles than graphite foil. FIG. 10C shows that the specific discharge capacity of the 3D graphite film electrode (142 mAh/gc after stabilization in 100 cycles) is near three times higher than the graphite foil (51 mAh/gc after stabilization in 100 cycles), suggesting that much higher utilization of the 3D graphite. The 3D graphite electrode also showed a good rate capability (FIGS. 10D-10E) at currents of 186, 372, and 744 mA/gc. The specific capacity of the 3D graphite electrode quickly approached the highest value with cycling number at a current density of 186 mA/gc in FIG. 10E, suggesting the graphite particles in the film electrode were much easier to be intercalated by AlCl₄⁻ due to the short diffusion path and high surface area. The Coulombic efficiency (CE) changed from 96% at 186 mA/gc to 98.2% at 744 mA/gc in FIG. 10E, which could be attributed to some unstable intercalation of AlCl₄⁻ in the graphite interlayers. At a very higher current of 2.98 A/gc, the specific capacity can remain ˜80% after 3000 cycles based on the fully active capacity (95 mAh/gc at 330^{th} cycle). The CE did not change much from 744 mA/gc (˜98.2%) to 2.98 A/gc (˜98.3%), which suggests that ˜2% of instable intercalation of AlCl₄⁻ or some side reactions (Cl⁻ to Cl₂) (ref. 24) cannot be avoided in this Al/graphite battery chemistry.

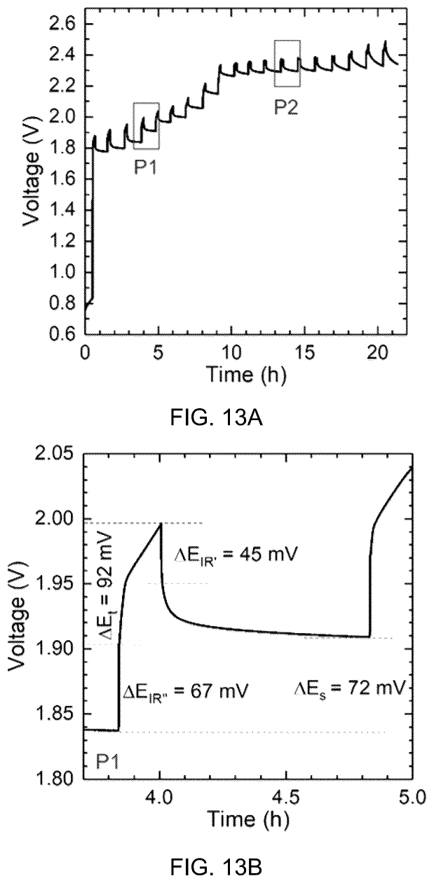

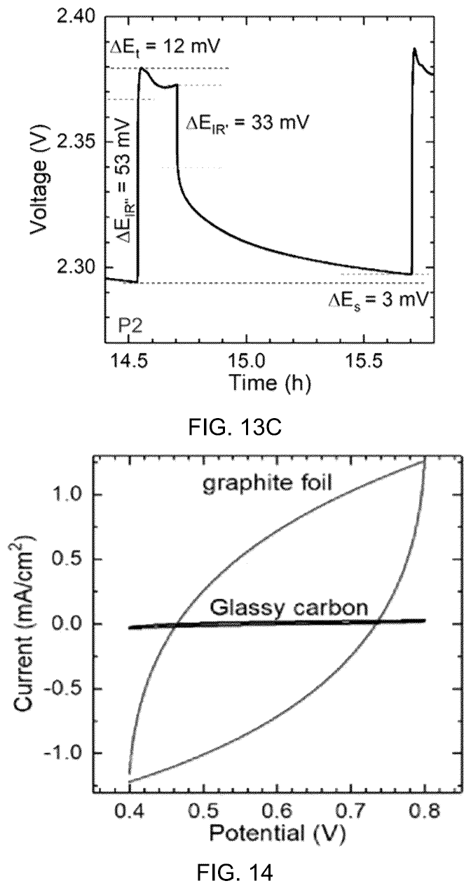

To understand the reason for the low utilization of graphite foil, the AlCl₄⁻ diffusion was investigated in graphite interlayers through the galvanostatic intermittent titration technique (GITT). As shown in FIG. 13A, the GITT measurement in the charge with two clear redox processes was conducted on an Al/graphite two-electrode cell. The selected two points of P1 (FIG. 13B) and P2 (FIG. 13C) were used to calculate the diffusion coefficients of AlCl₄⁻ in the graphite interlayers at two different charging stages. In stage P2, the charging voltage was firstly boosted to 2.38 V, and then the voltage went down to 2.37 V. It suggests the AlCl₄⁻ intercalation barrier became smaller after the initial intercalation of AlCl₄⁻ into graphite interlayers. The diffusion coefficient can be calculated based on the following equation (ref. 25):

$${D}^{GITT} = \frac{4}{π t} {( \frac{{m}_{B} {ϑ}_{B}}{{M}_{B} S} )}^{2} {( \frac{Δ {E}_{s}}{Δ {E}_{t}} )}^{2}$$

Where, t: the constant current pulse time (600 s); m_{B}, v_{B} and M_{B}: the mass (18.22 mg), the molar volume (5.27 cm³/mol), and the molar mass (12 g/mol) of the active materials; S: the area of the electrode-electrolyte interface; DEₛ: the change of the steady-state voltage during a single GITT step; DEₜ: the total change of the cell voltage during a constant current pulse t of a single-step GITT experiment neglecting the IR-drop.

To get the effective area of the electrode-electrolyte interface, the capacitance of graphite foil and glassy carbon foil was compared. As shown in FIG. 14, the area capacitance of graphite foil was 62 times higher than the glassy carbon foil. Therefore, the electrode-electrolyte interface of graphite foil is 62×1.27=78.4 cm². The diffusion coefficients in the two steps: D_{P1}=1.34*10⁻¹¹ cm²/s and D_{P2}=1.37*10⁻¹² cm²/s. The value is only slightly higher than the Li⁺ ion diffusion in the LiCoO₂ (10⁻¹¹ to 10⁻¹³ cm²/s)²⁶. Therefore, it is believed that the slow AlCl₄⁻ diffusion in graphite is the limiting factor in achieving higher rate capability. Therefore, the graphite film electrode with high surface area and 3D ion and electron networks can overcome the slow diffusion of AlCl₄⁻ by shorting its diffusion pathway, showing high graphite utilization and good rate capability (FIG. 10E and FIG. 10F).

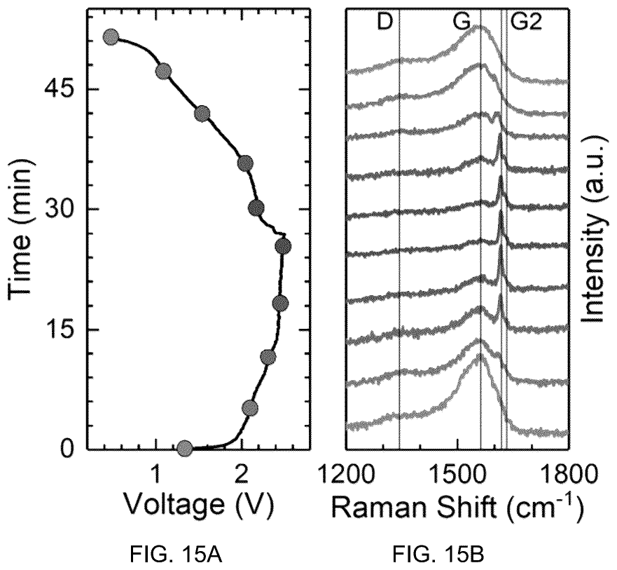

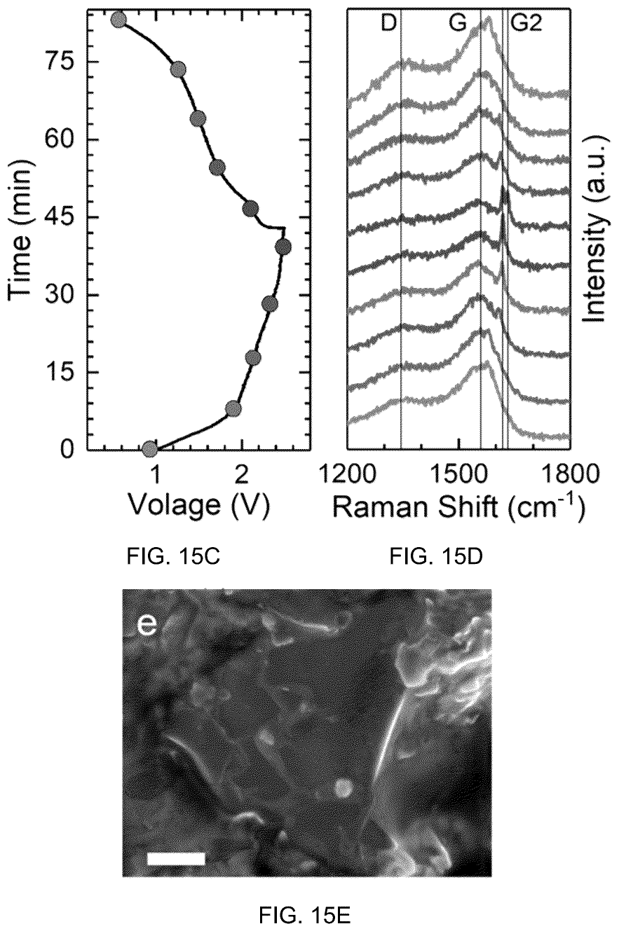

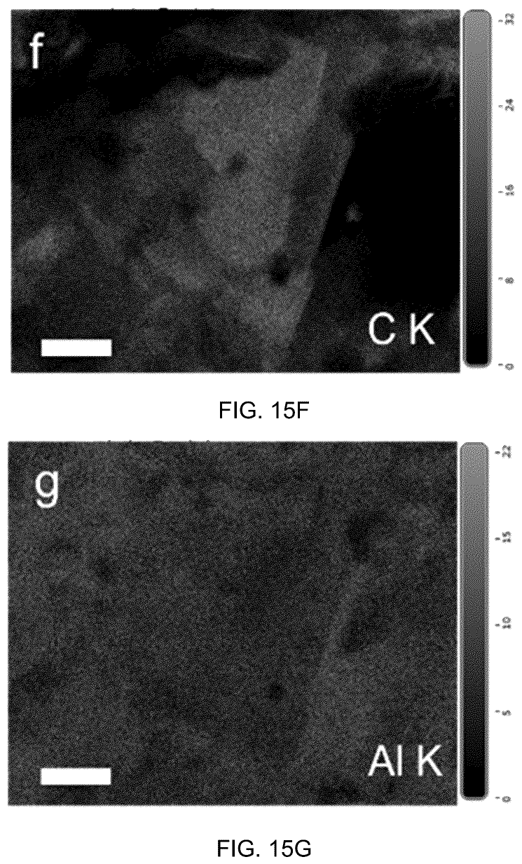

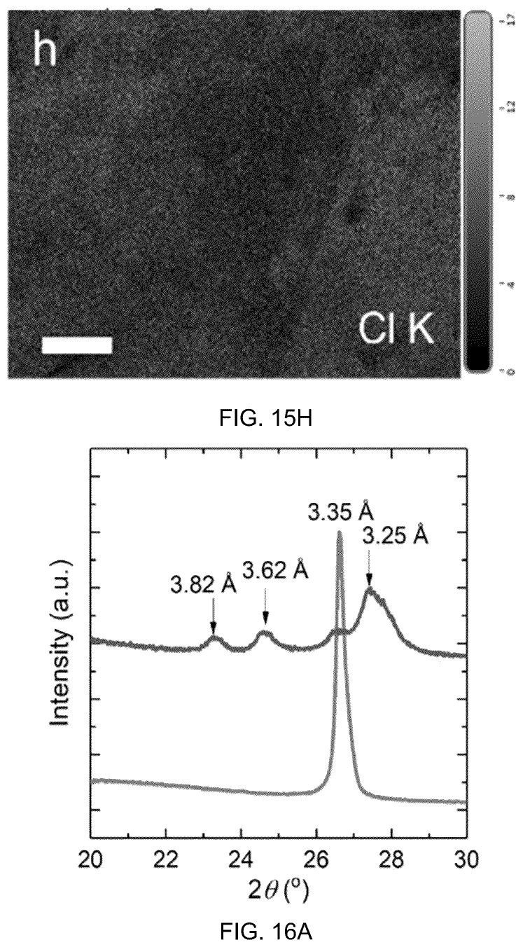

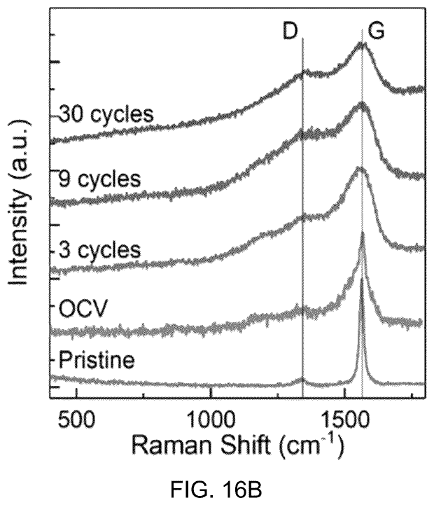

To understand the activation process of 3D graphite film electrodes, in-situ Raman spectroscopy measurements were conducted. The Raman spectra of the 3D graphite electrode were collected in cycle 3, as shown in FIGS. 15A-15B. The specific discharge capacity was only around 72 mAh/gc. The slightly lower specific capacity in FIG. 10E should be attributed to the poor electrode contact in the in-situ Raman cell. Through the Raman spectra in FIG. 15B, the G band decreased and the G2 band increased with charging, indicating the AlCl₄⁻ intercalation in graphite interlayers. The peak shifted to the lower angel in the XRD pattern²⁷ of the fully charged 3D graphite electrode (FIG. 16A), confirming the expansion of the graphite interlayer after AlCl₄⁻ intercalation. After discharge, the G2 band disappeared, and the G band was back, suggesting a reversible AlCl₄⁻ intercalation/deintercalation process. In cycle 100, the reversible AlCl₄⁻ intercalation/deintercalation process could still be seen with a higher specific discharge capacity (˜126 mAh/gc). With higher specific capacity in the 100^{th} cycle, the G2 band after fully charging was different from the one in cycle 3. The G2 band at 1633 cm⁻¹ showed much stronger than the G2 band at 1616 cm⁻¹, which is consistent with the previous study using pyrolytic graphite electrode. (ref. 3) Compared to Raman spectra in cycle 3, the D band became much stronger in cycle 100, which should be attributed to more disordered graphite lattice after more times of AlCl₄⁻ intercalation/deintercalation in graphite interlayers. FIG. 16B can further support that the D band changed only when the electrode went through electrochemical AlCl₄⁻ intercalation/deintercalation cycles. After fully charged, the 3D graphite electrode was characterized by SEM (FIG. 15E) and EDS (FIGS. 15F-15H). Through the EDS, the Al and Cl signals were observed in the graphite particles, indicating the successful intercalation after charging.

In general, PVDF-HFP copolymer was used as the ionic conductive gel electrolyte and binder to make the 3D Al and graphite film electrode. The high surface area of Al plating sites on the 3D Al/AB/PVDF-HFP film electrode results in the high rate capability (up to 20 mA/cm²_{geo} with <0.2 V of overpotential) and long cycling life (>500 h). Meanwhile, the high surface graphite particles also dramatically increased the specific capacity (˜142 mAh/gc at 168 mA/gc), almost three times higher than natural graphite foil. The in-situ Raman spectra revealed the reversible intercalation and deintercalation of AlCl₄⁻ in graphite interlayers and disordered structure of graphite particles with cycling numbers. Through the design of 3D electron and ion diffusion networks, the Al-graphite dual ion battery with a high rate capability and long cycling life is successfully demonstrated.

The following references (identified as “ref” above) are incorporated by reference in their entirety.
1 D. Larcher and J. M. Tarascon, Nat. Chem. 7 (1), 19 (2015).
2 L. E. Blanc, D. Kundu, and L. F. Nazar, Joule 4 (4), 771 (2020).
3 M.-C. Lin, M. Gong, B. Lu, Y. Wu, D.-Y. Wang, M. Guan, M. Angell, C. Chen, J. Yang, B.-J. Hwang, and H. Dai, Nature 520 (7547), 324 (2015).
4 R. P. Ramasamy and A. J. Hurd, MRS Energy & Sustainability 8 (1), 16 (2021).
5 J. Xie and Q. Zhang, Small 15 (15), 1805061 (2019).
6 B. J. Hopkins, Y. Shao-Horn, and D. P. Hart, Science 362 (6415), 658 (2018).
7 Z. Hu, Y. Guo, H. Jin, H. Ji, and L.-J. Wan, Chem. Commun. 56 (13), 2023 (2020).
8 J. Ma, J. Wen, J. Gao, and Q. Li, Electrochim. Acta 129, 69 (2014).
9 Z. Sun and H. Lu, J. Electrochem. Soc. 162 (8), A1617 (2015).
10 T. Mandai and P. Johansson, J. Mater. Chem. A 3 (23), 12230 (2015).
11 H. Wang, S. Gu, Y. Bai, S. Chen, F. Wu, and C. Wu, ACS Appl. Mater. Interfaces 8 (41), 27444 (2016).
12 G. A. Elia, K. V. Kravchyk, M. V. Kovalenko, J. Chacón, A. Holland, and R. G. A. Wills, Journal of Power Sources 481, 228870 (2021).
13 J. Zheng, D. C. Bock, T. Tang, Q. Zhao, J. Yin, K. R. Tallman, G. Wheeler, X. Liu, Y. Deng, S. Jin, A. C. Marschilok, E. S. Takeuchi, K. J. Takeuchi, and L. A. Archer, Nat. Energy 6 (4), 398 (2021).
14 H. Chen, H. Xu, B. Zheng, S. Wang, T. Huang, F. Guo, W. Gao, and C. Gao, ACS Appl. Mater. Interfaces 9 (27), 22628 (2017).
15 S. Das, S. S. Manna, and B. Pathak, ACS Omega 6 (2), 1043 (2021).
16 S. K. Das, S. Mahapatra, and H. Lahan, J. Mater. Chem. A 5 (14), 6347 (2017).
17 G. A. Elia, I. Hasa, G. Greco, T. Diemant, K. Marquardt, K. Hoeppner, R. J. Behm, A. Hoell, S. Passerini, and R. Hahn, J. Mater. Chem. A 5 (20), 9682 (2017).
18 C. Li, J. Patra, J. Li, P. C. Rath, M.-H. Lin, and J.-K. Chang, Advanced Functional Materials 30 (12), 1909565 (2020).
19 K. V. Kravchyk, S. Wang, L. Piveteau, and M. V. Kovalenko, Chem. Mater. 29 (10), 4484 (2017).
20 Y.-C. Lu, H. A. Gasteiger, M. C. Parent, V. Chiloyan, and Y. Shao-Horn, Electrochemical and Solid-State Letters 13 (6), A69 (2010).
21 J. Eaves-Rathert, K. Moyer, M. Zohair, and C. L. Pint, Joule 4 (6), 1324 (2020).
22 Y. G. Zhu, T. M. Narayanan, M. Tulodziecki, H. Sanchez-Casalongue, Q. C. Horn, L. Meda, Y. Yu, J. Sun, T. Regier, G. H. McKinley, and Y. Shao-Horn, Sustainable Energy Fuels (2020).
23 Y. G. Zhu, T. M. Narayanan, Y. Katayama, and Y. J. J. o. T. E. S. Shao-Horn, 168 (12), 120529 (2021).
24 J. Wang, Y. Hu, Y. Li, X. Gao, X. Wu, and Z. Wen, Journal of Power Sources 453, 227843 (2020).
25 E. Deiss, Electrochim. Acta 50 (14), 2927 (2005).
26 H. Xia, L. Lu, and G. Ceder, Journal of Power Sources 159 (2), 1422 (2006).
27 C.-J. Pan, C. Yuan, G. Zhu, Q. Zhang, C.-J. Huang, M.-C. Lin, M. Angell, B.-J. Hwang, P. Kaghazchi, and H. Dai, Proceedings of the National Academy of Sciences 115 (22), 5670 (2018).

The foregoing is merely an illustrative example. Other implementations may be made without departing from the scope of the disclosure. Reference numbers in parentheses “( )” herein refer to the corresponding references listed in the attached Bibliography, which forms a part of this Specification, and each of the references listed in the Bibliography is incorporated by reference herein. It should be understood that the subject matter defined in the appended claims is not necessarily limited to the specific implementations described above. The specific implementations described above are disclosed as examples only.

What is claimed is:

1. An aluminum electrode for a battery comprising aluminum powder and a gel polymer as a binder.

2. The aluminum electrode of claim 1, further comprising an electrically conductive network.

3. The aluminum electrode of claim 1, wherein the electrically conductive network includes carbon black, a carbon nanomaterial, graphene, graphite, a conductive polymer, acetylene black, ketjen black, or inert metal particles.

4. The aluminum electrode of claim 3, wherein the carbon nanomaterial includes carbon nanotubes or fullerenes.

5. The aluminum electrode of claim 1, wherein the electrically conductive network includes acetylene black.

6. The aluminum electrode of claim 1, wherein the gel polymer includes a fluorinated polyolefin, polyacrylonitrile (PAN), poly(ethylene oxide) (PEO), poly(vinylidene fluoride) (PVDF), or poly(methyl methacrylate) (PMMA).

7. The aluminum electrode of claim 6, wherein the fluorinated polyolefin includes a polyvinylidene fluoride, a polytetrafluoroethylene, a polyhexafluoropolypropylene, or a combination thereof.

8. The aluminum electrode of claim 6, wherein the fluorinated polyolefin is a copolymer of a polyvinylidene fluoride, a polytetrafluoroethylene, a polyhexafluoropolypropylene, or a combination thereof.

9. The aluminum electrode of claim 1, wherein the gel polymer includes poly(vinylidene fluoride)-co-hexafluoropropylene.

10. A carbon electrode for a battery comprising a carbon powder and a gel polymer as a binder.

11. The carbon electrode of claim 10, wherein the carbon powder includes carbon black, a carbon nanomaterial, graphene, graphite, a conductive polymer, acetylene black, or ketjen black.

12. The carbon electrode of claim 11, wherein the carbon nanomaterial includes carbon nanotubes or fullerenes.

13. The carbon electrode of claim 10, wherein the gel polymer includes a fluorinated polyolefin, polyacrylonitrile (PAN), poly(ethylene oxide) (PEO), poly(vinylidene fluoride) (PVDF), or poly(methyl methacrylate) (PMMA).

14. The carbon electrode of claim 13, wherein the fluorinated polyolefin includes a polyvinylidene fluoride, a polytetrafluoroethylene, a polyhexafluoropolypropylene, or a combination thereof.

15. The carbon electrode of claim 13, wherein the fluorinated polyolefin is a copolymer of a polyvinylidene fluoride, a polytetrafluoroethylene, a polyhexafluoropolypropylene, or a combination thereof.

16. The carbon electrode of claim 13, wherein the fluorinated polymer includes poly(vinylidene fluoride)-co-hexafluoropropylene.

17. A dual-ion battery comprising:
an aluminum electrode of claim 1; and
an electrolyte.

18. The dual-ion battery of claim 17, further comprising a carbon electrode and a separator between the aluminum electrode and the carbon electrode.

19. The dual-ion battery of claim 17, wherein the electrolyte comprises an ionic liquid electrolyte.

20. The dual-ion battery of claim 19, wherein the ionic liquid electrolyte includes a chloride salt.

21. The dual-ion battery of claim 19, wherein the ionic liquid electrolyte includes an imidazolium chloride.

22. The dual-ion battery of claim 19, wherein the ionic liquid electrolyte includes 1-ethyl-3-methylimidazolium chloride and aluminum chloride.

23. A method of manufacturing an electrode comprising:
casting a mixture of a gel polymer and an electrically conductive material selected from the group consisting of carbon black, a carbon nanomaterial, graphene, graphite, a conductive polymer, acetylene black, ketjen black, or inert metal particles to form a wet film; and
drying the wet film.

24. The method of claim 23, further comprising including metal particles in the mixture.

25. The method of claim 24, wherein the metal particles include aluminum powder.

26. The method of claim 23, wherein the electrically conductive material includes acetylene black or graphite powder.

27. The method of claim 23, wherein the gel polymer includes a fluorinated polyolefin, polyacrylonitrile (PAN), poly(ethylene oxide) (PEO), poly(vinylidene fluoride) (PVDF), or poly(methyl methacrylate) (PMMA).
